(19) United States
(12) Patent Application Publication
(10) Pub. No.: US 2010/0059958 A1
(43) Pub. Date: Mar. 11, 2010

(54) Heavy vehicle sway bar with redundancy (backup safety feature)

(75) Inventors: Brent Johnston, Milan, OH (US); Ronald McLaughlin, Maumee, OH (US)

Correspondence Address: HARNESS, DICKEY & PIERCE, P.L.C., P.O. BOX 828, BLOOMFIELD HILLS, MI, 48303, US

(73) Assignee: The Pullman Company, Milan, OH (US)

(21) Appl. No.: 12/283,283

(22) Filed: Sep. 10, 2008

(51) Int. Cl. B60G 21/055

(52) U.S. Cl. 280/124.106

(57) ABSTRACT

A sway bar assembly has a tubular bar extending between two mounts. A pair of brackets mount the center section of the tubular bar to a vehicle. A first solid bar extends from the first mount to one of the brackets and a second solid bar extends from the second mount to the other bracket. The solid bars provide a redundancy of back-up features for the sway bar assembly.

### FIELD

The present disclosure relates to sway bars. More particularly, the present invention relates to a sway bar which includes a redundancy or backup safety feature.

### BACKGROUND

The statements in this section merely provide background information related to the present disclosure and may not constitute prior art.

Sway bars or anti-roll bars are used in vehicles to adjust the torque of the suspension which then influences the roll rate. Sway bars are typically torsional springs which act across an axle to introduce resistance to relative changes in the displacement of one wheel on the axle compared to the displacement of the other wheel on the same axle. The sway bar or torsion spring is constrained both radially and axially and it is connected to the suspension member by a lever arm or by a linkage. The torsional spring rate or the sway bar contributes to the roll stiffness for the vehicle.

Roll stiffness is important to both the ride comfort and the cornering ability of the vehicle. Too little roll stiffness results in excess body roll or lean and slow response to the rotation of the steering wheel by the driver. On the other hand, too much roll stiffness creates an uncomfortable ride and can cause a sudden loss of traction and the ability of the tires to stick to the road during cornering maneuvers.

Sway bars are increasingly being required to withstand higher loads and stresses. Sway bars are typically formed from a bar or a tube having a generally circular cross-section. The bar is bent into the required shape to form arm sections and to fit and function in the particular vehicle application. Multi-piece sway bars are also known where a central bar is attached to a pair of spring elements or arm sections by welding or other means known in the art. The ends of the arm section of the sway bar connect to each end of the axle near the wheel typically with the bushings, ball joints, prop links or other methods known in the art. The center section is attached to the vehicle frame or other support structure using pivot connections.

### SUMMARY

The present disclosure provides a sway bar which has a redundancy (fail safe) or backup feature to hold the sway bar together should a component fail at a position outside the pivot connections for the center section. In the prior art, if a failure occurs in the position outside the pivot connections, the result is a complete loss of function of the sway bar and partial loss of axle stability typically requiring the immediate removal of the vehicle from service. The redundant or backup feature of the present disclosure will provide a limited function of the sway bar allowing the vehicle to continue to be driven prior to replacement or repair of the sway bar.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a perspective view of the installation of a sway bar in accordance with the present disclosure;

FIG. 2 is a perspective view of the sway bar and center section mounts illustrated in FIG. 1;

FIG. 3 is a perspective view, partially cross-section of the sway bar and center section mounts illustrated in FIG. 1; and

FIG. 4 is a cross-sectional view of one of the end assemblies of the sway bar illustrated in FIGS. 1 and 2.

### DETAILED DESCRIPTION

The following description is merely exemplary in nature and is not intended to limit the patent disclosure, application or uses.

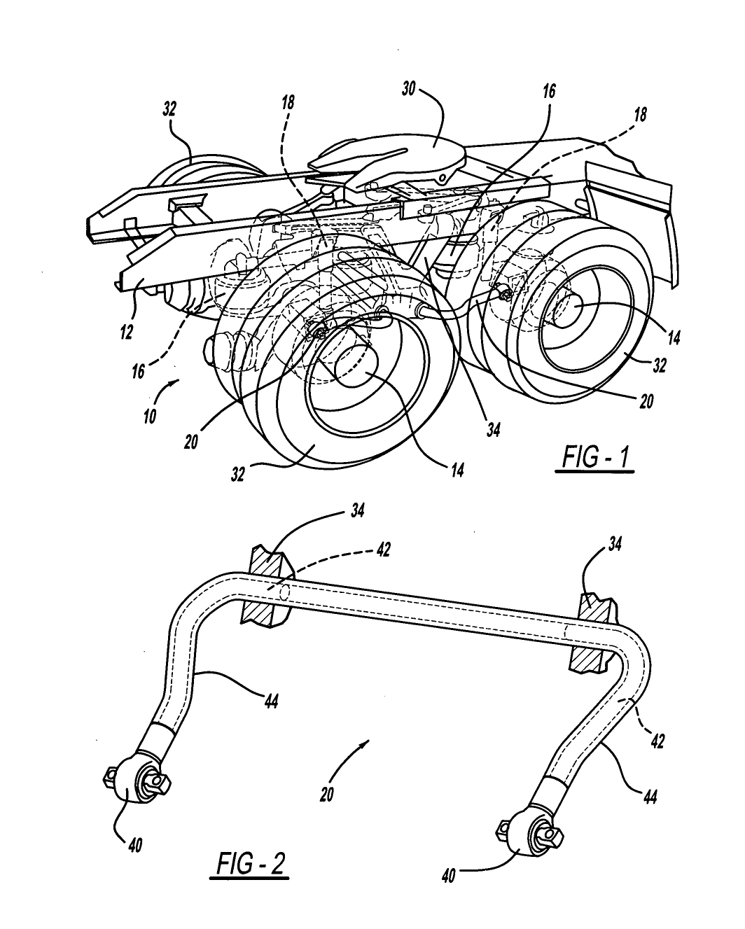

Referring now to the drawings in which like reference numerals designate like or corresponding parts throughout the several views, there is illustrated in FIG. 1 a typical vehicle suspension system 10. Vehicle suspension system 10 comprises a frame or support member 12 (sprung component), a pair of axle assemblies (unsprung component) 14, a plurality of springs 16, a plurality of shock absorbers 18 and a pair of sway bar assemblies 20. While sway bar assemblies 20 are illustrated in conjunction with a typical truck suspension, it is within the scope of the present disclosure to utilize sway bar assemblies 20 in any vehicle suspension system.

Frame or support member 12 supports a fifth-wheel 30 which is utilized for the attachment of a trailer or other component to a cab (not illustrated) also supported by frame or support member 12. Each axle assembly 14 supports a plurality of road wheels 32 as is well known in the art. Frame or support member 12 is attached to each of the axle assemblies 14 using four springs 16. Springs 16 are illustrated as air springs but is within the scope of the present disclosure to utilize any type of spring in suspension system 10. A pair of shock absorbers 18 extend between frame or support member 12 and each axle assembly 14 to dampen the motion between frame or support member 12 and axle assembly 14.

Each sway bar assembly 20 is attached between a respective axle assembly 14 and frame support member 12. As illustrated in FIG. 1, a mounting bracket 34 mounts the center portion of each sway bar assembly 20 to each side of frame or support member 12 (only one side illustrated in FIG. 1) and the ends of each sway bar assembly 20 are mounted to opposite sides of a respective axle assembly 14 adjacent a respective road wheel 32.

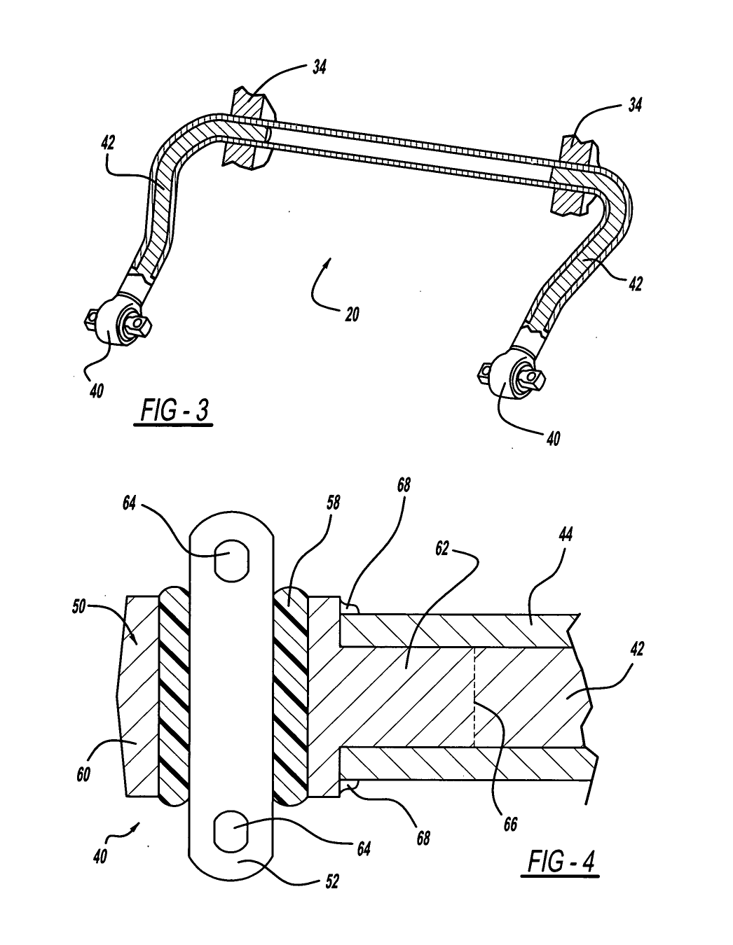

Referring now to FIGS. 2 and 3, sway bar assembly 20 and mounting brackets 34 are illustrated in greater detail. Sway bar assembly 20 comprises a pair of mounts in the form of bushing assemblies 40, a pair of inner solid rods 42 and an outer tubular rod 44.

Each inner solid rod 42 is attached at one end to a respective bushing assembly 40 and its opposite end extends through mounting bracket 34 such that mounting bracket 34 supports the end of inner solid rod 42. While inner solid rod 42 is illustrated as a solid rod, inner solid rod 42 can also be a tubular rod. Also, while sway bar assembly 20 is being illustrated as having two identical inner solid rods 42, it is within the scope of the present disclosure to utilize two different inner solid rods to accommodate a specific application.

Outer tubular rod 44 is attached at one end to one of the bushing assemblies 40 and is attached at its opposite end to the other bushing assembly 40. Outer tubular rod 44 extends through both mounting brackets 34 such that the center section of the sway bar assembly 20 is supported by each mounting bracket 34. Thus, as illustrated in FIGS. 2 and 3, each mounting bracket 34 supports both inner solid rod 42 and outer tubular rod 44, both of which extend through mounting bracket 34 in a co-axial manner. Outer tubular rod 44 is designed to be press fit over inner solid rod 42.

Referring now to FIG. 4, one bushing assembly 40 is illustrated in greater detail. While sway bar assembly 20 is illustrated using two identical bushing assemblies 40, it is within the scope of the present invention to utilize two different bushing assemblies to accommodate a specific application. Bushing assembly 40 comprises an outer member 50, an inner member 52 and an elastomeric member 58 disposed between outer member 50 and inner member 52.

Outer member 50 includes a cylindrical housing 60 and an attachment cylinder 62 extending radially outward from cylindrical housing 60. Inner member 52 extends through cylindrical housing 60 and it defines two holes 64 which are used to attach sway bar assembly 20 to axle assembly 14. Elastomeric member 58 is disposed between inner member 52 and cylindrical housing 60 of outer member 50. Inner solid rod 42 is attached to attachment cylinder 62 of the outer member 50 by welding or by other means known in the art. As illustrated in FIG. 4, attachment cylinder 62 is a solid cylindrical member which is welded to inner solid rod 42 as indicated at 66. Outer tubular rod 44 is attached to cylindrical housing 60 of outer member 50 by welding or by other means known in the art as indicated at 68. As illustrated in FIG. 4, attachment cylinder 62 is inserted into outer tubular rod 44.

Outer tubular rod 44 is designed to be the primary torsional member. During typical loading conditions, the stresses in outer tubular rod 44 will be significantly higher than the stresses in inner solid rod 42. This will ensure that the backup feature, inner solid rod 42, will remain intact should there be a failure of the primary member, outer tubular rod 44. By having outer tubular rod 44 being designed as the primary torsional member, any failure of outer tubular rod 44 can be detected through routine inspection. Should outer tubular rod 44 fail, sway bar assembly 20 will remain intact due to inner solid rod 42 being held by mounting bracket 34 and extending to bushing assembly 40.

As illustrated, the welding of inner solid rod 42 to bushing assembly 40 and the welding of outer tubular rod 44 to bushing assembly 40 are staggered in the axial direction. The two welds can be in the same plane at the same axial position but the staggering of the two welds allows the weld between inner solid rod 42 and bushing assembly 40 to be supported by outer tubular rod 44 which is press fit over attachment cylinder 62 and inner solid rod 42.

The foregoing description of the embodiments has been provided for purposes of illustration and description. It is not intended to be exhaustive or to limit the invention. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the invention, and all such modifications are intended to be included within the scope of the invention.

What is claimed is:

1. A sway bar assembly comprising:
a first mount;
a second mount;
a first bar attached directly to said first and second mounts;
a second bar attached directly to said first mount; and
a third bar attached directly to said second mount.

2. The sway bar assembly according to claim 1 wherein said first bar is a tubular bar.

3. The sway bar assembly according to claim 2 wherein said second bar is a solid bar.

4. The sway bar assembly according to claim 3 wherein said third bar is a solid bar.

5. The sway bar assembly according to claim 1 wherein said second bar is a solid bar.

6. The sway bar assembly according to claim 5 wherein said third bar is a solid bar.

7. The sway bar assembly according to claim 1 wherein said first bar is a tubular bar, said second and third bars being disposed within said tubular bar.

8. The sway bar assembly according to claim 1 wherein said first mount comprises a first outer member, a first inner member and a first elastomeric member disposed between said first inner member and said first outer member.

9. The sway bar assembly according to claim 8 wherein said second mount comprises a second outer member, a second inner member and a second elastomeric member disposed between said second inner member and said second outer member.

10. The sway bar assembly according to claim 9 wherein said first bar is a tubular bar.

11. The sway bar assembly according to claim 10 wherein said second bar is a solid bar.

12. The sway bar assembly according to claim 11 wherein said third bar is a solid bar.

13. The sway bar assembly according to claim 1 further comprising a first bracket attached to said first bar and a second bracket attached to said first bar.

14. The sway bar assembly according to claim 13 wherein said second bar extends from said first mount to said first bracket.

15. The sway bar assembly according to claim 14 wherein said third bar extends from said second mount to said second bracket.

16. The sway bar assembly according to claim 13 wherein said first bar is a tubular bar.

17. The sway bar assembly according to claim 16 wherein said second bar is a solid bar.

18. The sway bar assembly according to claim 17 wherein said third bar is a solid bar.

19. The sway bar assembly according to claim 13 wherein said first bar is a tubular bar, said second and third bars being disposed within said tubular bar.

20. The sway bar assembly according to claim 19 wherein said first bar extends from said first mount to said first bracket and said second bar extends from said second mount to said second bracket.
